(19) United States
(12) Patent Application Publication
(10) Pub. No.: US 2019/0092919 A1
(43) Pub. Date: Mar. 28, 2019

(54) IMPROVED SYSTEM AND PROCESS FOR THE MANUFACTURE OF POLYMER FOAM WITH ADDITIVES

(71) Applicant: RCO ENGINEERING INC., Roseville, MI (US)

(72) Inventor: Kenneth A Drew, Troy, MI (US)

(21) Appl. No.: 16/085,629

(22) PCT Filed: Mar. 16, 2017
(86) PCT No.: PCT/US2017/022843

§ 371 Date: Sep. 17, 2018

Related U.S. Application Data
(60) Provisional application No. 62/308,950, filed on Mar. 16, 2016.

(51) Int. Cl. C08J 9/00; C08G 18/08; C08K 3/04

(52) U.S. Cl. CPC C08J 9/0066; C08G 18/14; C08K 5/0066; C08J 2201/022; C08J 2375/04; C08K 3/04

(57) ABSTRACT

In order to eliminate unwanted interactions between catalysts and additives in polymerization reactions, one of the reactant streams is split into two parts, one which is mixed with additives, and the other with catalysts. The separation of these two parts eliminates the unwanted reactions between additives and catalysts prior to the polymerization reaction. In the case of polyurethane foam reactions, the reaction catalysts can be separated from additives that provide flame-block characteristics, such as expandable graphite. The two parts of the reactant stream are then recombined with the second reactant in specific ratios in order to achieve the desired polymerization reaction and resulting polymer product.

### CROSS-REFERENCE TO RELATED APPLICATIONS

The present invention claims the benefit of the filing date of Provisional Application No. 62/308,950, filed Mar. 16, 2016 and entitled “Graphite Foam Process,” the contents of which are incorporated herein by reference.

### BACKGROUND OF THE INVENTION

### 1. Field of the Invention

The present invention relates to a method for manufacturing cellular polymer foam having certain additives, such as fire-block polyurethane foam, and particularly a method that minimizes the negative impact of interactions caused by reaction catalysts and additives during the production process.

### 2. Description of Related Art

Polyurethane foams have advantageous physical and mechanical properties that make them desirable materials for a wide range of applications. Polyurethane foam, however, can be highly flammable. The morphological structure of polyurethane foam, consisting of closed- or open-celled structures, provides increased surface area per unit volume and an insulated, heat-retaining structure such that, when exposed to direct heat in an oxygen environment, nearly complete pyrolysis can occur. The flammability of the foams can be further increased by the potential presence of flammable blowing agents inside the foam cells.

In U.S. Pat. No. 4,698,369, Dunlop, through its inventor Raymond Bell, proposed incorporating expandable graphite into the foam-forming reaction as a means to reduce or eliminate foam flammability. Expandable graphite is formed from crystalline graphite flakes, which are intercalated with an expanding agent, such as sulfuric acid. When heated suddenly, the sulfuric acid reacts with the carbon to form a blowing agent, which forces the crystalline graphite layer apart, rapidly expanding the structure a hundred times over. The expanded graphite is low-density and non-flammable, and acts as a thermal heat shield insulating the underlying polyurethane foam, and smothering any flame inside the foam.

Conventional polyurethane manufacturing techniques incorporate additives like expandable graphite in order to affect the physical properties of the finished product. Polyurethane is manufactured by combining a resin stream, usually consisting of a polyol and one or more reaction catalysts, with a stream of isocyanate. The combination of the two streams is metered carefully at a controlled temperature and a specific stoichiometric ratio in order to create a homogenous blend for dispensing into a mold or spraying onto a surface. The additives are conventionally included in the polyol stream in order to control the color, appearance, sound absorption, smoke toxicity, and fire suppression of the final product.

To create polyurethane foam, the polyurethane reaction additionally includes either chemical or physical blowing to create a gas inside the combined reacting liquid. Chemical blowing is based on the inclusion of water within the resin stream, which reacts with isocyanate to create carbon dioxide gas bubbles. Physical blowing, on the other hand, is facilitated by the inclusion of a low-boiling point liquid in the polyol stream. Because the polyurethane reaction is exothermic, the heat of reaction drives the creation of the gas in the combined liquid, either by promoting the creation of carbon dioxide or by vaporizing the low-boiling point liquid. In short, consistent quality polyurethane foam structures are dependent in part on maintaining consistent and predictable reaction temperatures.

A typical polyurethane blown-foam process is shown in U. S. Publication No. 2014/0339336, filed on behalf of Ogonowski. In Ogonowski, two reactant tanks are provided, one containing polyisocyanate, and the other containing the resin composition with additives (like expandable graphite) and reaction catalysts. The two reactant streams are combined at an assembly in a pre-defined ratio, and then sprayed to create polyurethane blown foam with the desired additives included. A similar system is disclosed in U.S. Publication No. 2013/0119152, filed on behalf of Wishneski, in which a first stream containing resin with catalyst and additives, and a second stream containing isocyanate are proportionately combined, then heated and sprayed to form polyurethane foam.

These conventional systems fail to recognize the adverse effect the presence of an additive like expandable graphite can have on the efficiency and efficacy of polyurethane foam formation. The sulfuric acid included in expandable graphite is highly reactive and can interfere with the reaction catalysts in polyurethane resin, resulting in decreased foam rise time and therefore higher foam density. When left in contact with the resin for a sufficient period of time, the sulfuric acid can render the resin completely unreactive.

Conventional systems also fail to recognize the negative effect a physically-solid additive like expandable graphite can have on maintaining reaction temperature, and therefore foam quality. Additives in the solid state can act as a heat sink robbing the heat of reaction created by the catalysts and the isocyanate. Without this reaction heat the gas required as a blowing agent is not created fast enough and in sufficient quantity to allow the foam to rise as desired. This negative result requires more polyurethane liquid to be added to a part in order to fill a given mold, which increases its density and consequently its weight.

While it might seem possible to simply elevate the temperature of the additive and resin mixture to reduce the heat sink effect, any abnormal temperature increase also increases the negative reaction between the additive and the resin catalyst. Instead of helping promote better foam structure, additional heat accelerates the degradation of the whole foaming system.

### SUMMARY OF THE INVENTION

The present invention overcomes the problems of the prior art, and other problems, through the use of a novel method of storing and then combining the catalytic, reactive and additive components of the polyurethane reaction.

With the foregoing and other objects in mind, the present invention uses a system and method for producing polymeric product in which the reactants of a polymerization reaction are selected for use in order to produce a desired polymeric product. Preferably, the polymeric product is polyurethane foam, and the reactants are polyol and isocyanate. An appropriate catalyst is also selected for enabling or accelerating the polymerization reaction, and an additive is selected for producing a desired characteristic of the polymeric product. Preferably, an additive is selected to provide a fire-block characteristic of the polymeric product, such as expandable graphite.

Once selected, a first portion of one of the reactants is put in a first storage container along with the additive, and a second portion of the same reactant is put into a second storage container along with the catalyst. The amount of the additive and the catalyst contained in their relative containers is sufficient to enable and/or accelerate the polymeric reaction between the first and second reactants, and produce the polymeric product having the desired additive characteristic.

To determine the amount of additive in the first mixture, the total amount of the first reactant needed for the desired polymerization reaction should be selected, along with the ratio of the additive to the first reactant needed for the polymerization, after which the total amount of additive for the polymerization reaction can be calculated.

Once placed in their storage containers, a first mixture of the first reactant and the additive is fed to a dispensing head, along with a second mixture of the first reactant and the catalyst, and a third stream of the second reactant. Together these three feeds are combined into a single mixture, and then dispensed from a dispensing device. Preferably, the three feeds continuously provide their relative mixtures to the dispensing device, and the dispensing device is capable of continuously dispensing the combined mixture onto a surface. After being dispensed, the combined mixture will cure into the final polymeric product.

The combination of the first mixture, second mixture, and second reactant into a combined mixture is preferably done with the components of each mixture in a particular ratio. This ratio can be achieved by determining flow rates for the first mixture, second mixture, and second reactant to the dispensing device that together will allow the polymerization reaction to proceed. Preferably, the flow rates would result in a stoichiometric ratio of the first reactant and the second reactant in the combined mixture.

### BRIEF DESCRIPTION OF THE DRAWINGS

FIG. 1 is a plan view of a system for implementing the present invention.

### DETAILED DESCRIPTION OF THE INVENTION

The present invention is a system to process polymers with additives having chemical properties that react negatively with the catalysts, and is particularly appropriate for the manufacture of polyurethane foam having fire-block additives.

The present invention evolved from observations of conventional polyurethane manufacturing processes using expandable graphite as an additive. It was observed that the inclusion of additives like expandable graphite had a significant and deleterious effect on foam formation and quality. Specifically, observations showed that polyurethane foaming was significantly reduced upon the addition of expandable graphite as compared to non-additive-based foams. It was also observed that heats of reaction were reduced, and foam quality suffered as well. Longer-term storage of polyurethane resin in the presence of expandable graphite resulted in reduced foaming reactions and some non-reactive resins. Based on these observations, the following inventive process was developed.

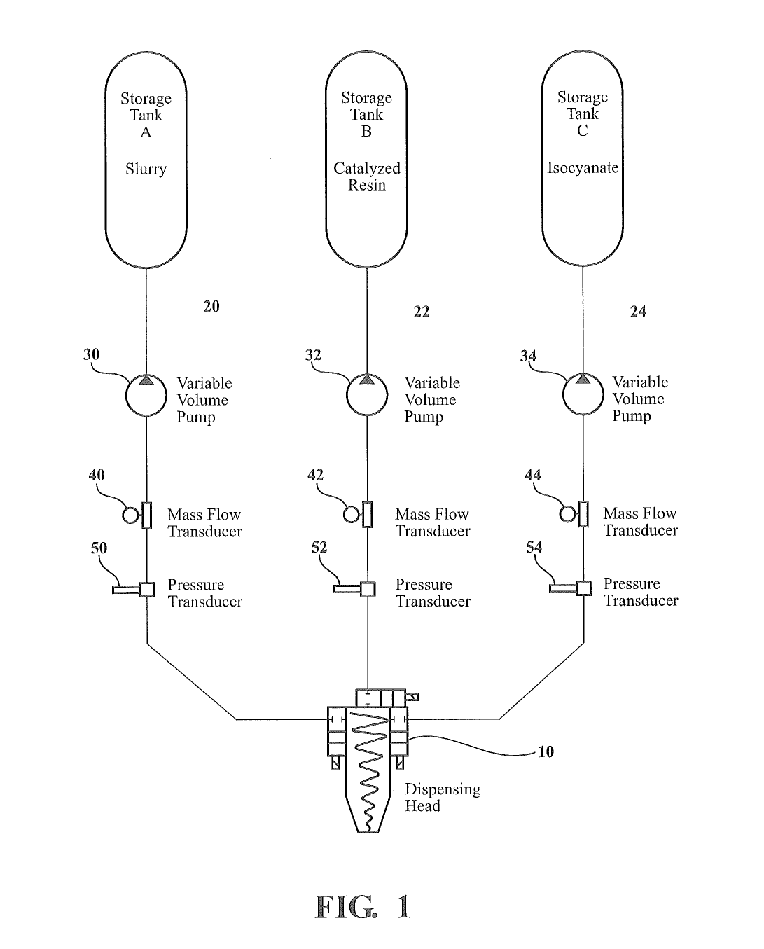

A preferred system for implementing the invention is shown in FIG. 1 for batch production. The system includes tanks A, B and C, for retaining reactants for the polymerization reaction. Tanks A, B, and C are connected to a dispensing head 10 through feed lines 20, 22, and 24. Each feed line 20, 22, and 24 preferably includes a variable volume pump 30, 32, 34 for controlling the relative amount of flow of reactant to the dispensing head 10 from each feed 20, 22 and 24, and either or both of a mass flow transducer 40, 42, 44 or pressure transducer 50, 52, 54, to measure reactant flow after the pump 30, 32, 34.

The method of the present invention eliminates the negative effects caused in prior art systems by segregating problematic reactants, additives, and catalysts in tanks A, B, and C. Thereafter, the reactants are fed at specific rates to be combined in specific ratios at the dispensing head, and then dispensed as the combined and desired polymer product.

For explanatory purposes, the present invention will be described in more detail with respect to the example of manufacturing polymeric foam. Polyurethane foam can be manufactured by mixing two or more liquid streams consisting of any number of known reactants, additives, catalysts, and other materials. Generally, polyurethane foam reactants include a di- or polyisocyanate, and a polyurethane resin consisting of a polyol, as well as catalysts, surfactants, blowing agents and other materials. Non-isocyanate reactants may be used as well. The polyurethane resin is sometimes called the “resin” or “resin blend,” while the isocyanate can be referred to as the “iso.” The resin and the iso are combined at a metered, stoichiometric ratio, and then mixed and dispensed to cure into the final product. The maintenance of specific ratios between the resin blend stream and the iso stream is critical to the polymerization reaction.

Catalysts are generally used to enable or accelerate the polymerization reaction, although catalysts may be included in the reaction process for other reasons as well. Certain of the catalysts and additives used in the polyurethane manufacturing process have negative interactions with each other, and can affect the efficiency of the manufacturing process and the quality of the resulting product. For example, expandable graphite, while effective for as a fire-block in the final product, can lower the reaction temperature of a polyurethane foam product, and can cause unwanted reactions with catalysts.

To eliminate these problems, the present invention divides the polyurethane resin into two portions, one with additives but without any catalyst that negatively interacts with additives and another without additives but with the negative-reactive catalyst. The non-catalyst resin portion, sometimes referred to as “the slurry,” is stored in Tank A. The catalyzed resin portion is stored in Tank 13. The third reactant, isocyanate, is stored in Tank C. By separating the slurry in Tank A from the catalyzed resin in Tank B, the negative interactions between additives like expandable graphite and other reaction catalysts normally in the polyurethane resin can be eliminated while in storage. In addition, the temperature of the slurry can also be elevated without concern for accelerating reactions between the catalysts and additive's chemistry. The two resin streams and the isocyanate can then be combined at dispensing head 10 at the proper ratios to make the desired polyurethane foam. The combination at the dispensing head 10 is preferably on a continuous basis, with feed lines 20, 22, and 24 continuously feeding their constituent liquid streams to the dispensing head 10, and the dispensing head 10, in turn, combining the streams and dispensing the combined liquid into the desired location.

Preferably, the slurry is heated prior to mixing to eliminate or reduce any heat-sink effects from the additives on the overall polymerization reaction.

In order to maintain the desired ratios of reactants, catalysts, and other materials when combined at the dispensing head 10, the typical ratio of certain materials in the materials stored in Tanks A, B and C must be changed. Polyurethane resin, for example, is normally purchased with a set ratio of catalyst by weight or volume to a set weight or volume of resin. Similarly, a known amount of resin is normally infused with a set amount of additive by weight or volume depending on the desired application and additive effect. Because the slurry in the present invention does not include any catalyst, however, the catalyst must be removed prior to the addition of any additives, or catalyst-free polyurethane resin must be procured. To accommodate for the lack of a catalyst in the slurry, and the lack of additive in the non-catalyzed resin portion, the relative weight or volume percentage of each must be increased in their respective mixtures in order to maintain an appropriate stoichiometric ratio for mixing.

For example, polyurethane resin may be procured from a supplier typically having a catalyst ratio of 1.5 parts by weight of catalyst to 100 parts by weight of resin, varying to different degrees to produce polyurethane foam with different process and physical properties. To facilitate introducing additives with reactive components to the polyurethane resin the catalysts are removed and a typical ratio of 1 part resin by weight to 1 part additive by weight is used to produce the slurry. To maintain the proper catalyst ratio for the polyurethane foam the catalyst ratio of the second stream of resin will need to be increased. The amount of catalyst increase will be determined by the final amount of additive required in the resin streams combined.

The following steps can be used to determine the amount of material needed in Tanks A, B, and C for the present method, as well as the desired flow rate of those materials from the Tanks for dispensing and curing.

First, there are several desired characteristics for the final polyurethane foam product that can be used to determine the amount and ratios of certain reaction components. For example, the amount of polyurethane resin needed for a particular application can be determined experimentally based on the size of the mold, the number of products to be made, and the desired hardness and weight of the resulting foam. And, depending on the desired characteristics from the additive, for example reduced flammability, the percentage of additive-to-total polyurethane can be determined. The methods for identifying these amounts and ratios are known to those of skill in the art.

Using the information regarding the amount of resin and the relative percentage of additive, the total amount of additive needed for the application can be calculated as follows:

X_{S}=P_{T}*A_{R}

Where:

P_{T} J Total amount of polyurethane resin (both streams) needed

A_{R}=Percentage of additive-to-total polyurethane needed for the application

X_{S}=Additive amount calculated for the overall polyurethane resin reactant

Second, the amount of additive needed for the total reaction can be calculated using these values, along with the desired resin-to-additive ratio for the slurry, as determined by the particular application. The resin-to-additive ratio can be determined experimentally for a particular application based on the equipment available, the capabilities of the facilities, and the desired end product, as would be known by one of ordinary skill in the art. For example, the lower the resin-to-additive ratio, the more difficult it is to pump the slurry through its feed line 20 up to the dispensing head 10. The higher the ratio, on the other hand, the more diluted the liquid becomes, and the more other portions of the system (discussed further below) will be affected and need adjustment. Once the ratio is determined, the amount of non-catalyzed resin to be used in the slurry can be calculated using the following equation:

Z_{P}=G_{S}*X_{S}

### Where:

G_{S}=Desired resin-to-additive ratio for the slurry

X_{S}=Additive amount calculated for the overall polyurethane resin reactant

Z_{P}=Amount of non-catalyzed resin for slurry

Third, the amount of catalyst needed for the catalyzed resin mixture can also be calculated. The percentage amount or part-by-weight of catalyst needed for a particular polymer reaction is generally provided by the manufacturer of the polymer resin, based on the product being made and the chemical reactants being used. Generally, however, the amount of catalyst is intended to be sufficient to efficiently and as completely as possible complete the desired polymerization reaction. Because the present invention splits the polyurethane resin into catalyzed and non-catalyzed (i.e. the slurry) portions, however, the amount of catalyst needed in the catalyzed resin mixture will be higher than in conventional resin mixtures. The percentage amount of catalyst needed in the catalyzed resin can be calculated using the following equation:

$${C}_{S} = {C}_{T} ( \frac{{Z}_{P}}{{P}_{T} - {Z}_{P}} ) + {C}_{T}$$

Where:

Z_{P}=Calculated amount of non-catalyzed resin

P_{T}=Total amount of polyurethane resin (both streams) to be used

C_{T}=Percentage of catalyst required for total polyurethane resin (both streams)

C_{S}=Percentage of catalyst required for the catalyzed resin mixture

After calculating the slurry content and the catalyst proportion for the catalyzed resin stream, the appropriate flow rates for each feed stream to the dispensing unit must be calculated. The flow rates can be conceptualized using the following equations:

D_{F}=I_{F}+N_{F}+S_{F}

I_{F}=I_{R}*P_{TF}

N_{F}=P_{TF}−P_{SF}

S_{F}=P_{SF}+G_{S}

G_{S}=P_{TF}*A_{R}

P_{SF}=S_{R}*G_{S}

Where:

D_{F}=Combined dispensing flow rate

I_{F}=Isocyanate flow rate

N_{F}=Catalyzed resin flow rate

S_{F}=Slurry flow rate

P_{SF}=Slurry polyurethane resin flow rate

P_{TF}=Total polyurethane resin (both streams) flow rate

G_{S}=Slurry polyurethane resin-to-additive ratio

A_{R}=Additive to total polyurethane resin percentage

A_{F}=Additive flow rate

T_{R}=Isocyanate to total resin ratio

S_{R}=Slurry additive to resin ratio

Starting with the equation for the combined dispensing flow rate (D_{F}), and substituting in other equations appropriately, the equation can be simplified as follows:

D_{F}=I_{F}+N_{F}+S_{F}

D_{F}=(I_{R}*P_{TF})+(P_{TF}−P_{SF})+(A_{R}*P_{TF}+S_{R}*A_{R}*P_{TF})

D_{F}=(I_{R}*P_{TF})+(P_{TF}−S_{R}*A_{R}*P_{TF})+(A_{R}*P_{TF}+S_{R}*A_{R}*P_{TF})

D_{F}=(1+I_{R}+A_{R})*P_{TF}

From this simplified equation, the combined dispensing flow rate (D_{F}) is a function of the ratio of the isocyanate to the total resin, identified as I_{R}, the percentage of additive-to-total polyurethane resin, identified as A_{R}, and the total polyurethane resin flow rate, identified as P_{TF}. The isocyanate/total resin ratio (I_{R}) is determined by the stoichiometric ratio necessary to achieve the polymerization reaction, and can generally be obtained from a resin supplier, experimentation, or calculations, as would be known by one of skill in the art. And, the additive-to-total polyurethane resin percentage is determined experimentally or historically based on the amount of polyurethane resin and the desired additive effect.

The equation for the dispensing flow rate (D_{F}) can be used to solve for the total polyurethane flow rate (P_{TF}). To achieve this result, the combined dispensing flow rate (D_{F}) must first be determined by application-specific needs, experimentally or otherwise as would be known by those of skill in the art. For example, a desired flow rate for the combined polyurethane foam liquid can be determined based on the size and shape of the mold being filled, the material being used, average cure time based on temperature and chemical makeup, and other conditions.

Once the polyurethane flow rate is calculated, the flow rates of the remaining parts of the system can be calculated as well. The calculations start by calculating the flowrates of component parts of the system, including the additive flow rate and the slurry polyurethane resin flow rate, as follows:

A_{F}=A_{R}*P_{TF}

P_{SF}=S_{R}*P_{TF}

Where:

P_{TF} Total polyurethane resin (both streams) flow rate

A_{F}=Additive flow rate

A_{R}=Additive-to-total polyurethane resin percentage

P_{SF}=Slurry polyurethane resin flow rate

S_{R}=Slurry additive-to-total polyurethane resin ratio

The total polyurethane resin flow rate, just calculated above, is used in these equations to calculate the flow rates of the parts of the slurry (additive and polyurethane resin) using the percentages of additive-to-total and additive-to-resin percentages/ratios. The selection of the additive-to-total polyurethane resin percentage was previously discussed. The additive-to-total polyurethane ratio is merely the inverse of the resin-to-additive ratio (G_{S}), also discussed previously.

From these numbers, the flow rates for the three components streams in the invention can be determined, using the equations below. The slurry flow rate is the combination of the slurry polyurethane flow rate and the additive flow rate, while the catalyzed resin flow rate is the difference between the total polyurethane resin flow rate and the slurry resin flow rate. The iso stream flow rate is determined by multiplying the total resin flow rate by the isocyanate/total resin ratio.

S_{F}=P_{SF}+A_{F}

N_{F}=P_{TF}−P_{SF}

I_{F}=I_{R}*P_{TF}

These flow rates, in turn, can be used to control the flow of the liquid through the feeds using the variable volume pumps, and through the dispensing head.

The following example is given by way of illustration.

The expandable graphite required for a certain polyurethane foam cushion is 25% by weight of the total polyurethane resin required. A one-to-one ratio of expandable graphite to non-catalyzed polyurethane resin is desired for the slurry. To produce the quantity of cushions required it is determined that 20 kg total of PU resin is required and to achieve the desired cushion firmness the urethane component supplier indicates that a one part isocyanate to two parts PU resin is required. Assume 1.5% catalyst for the combined PU resin content. The dispensing flow rate of the PU foam is given at 200 g per second.
1) Find the amount of expandable graphite required.
X_{S}=20 kg*0.25
X_{S}=5 kg
2) Find the required amount of non-catalyzed PU resin for the slurry.

$${Z}_{P} = {G}_{S} * {X}_{S}$$

$${Z}_{P} = \frac{{1}_{resin}}{{1}_{additive}} * 5 kg$$

$${Z}_{P} = 5 kg$$

3) Calculate catalyst content for second stream of PU resin.

$${C}_{S} = {C}_{T} ( \frac{{Z}_{P}}{{P}_{T} - {Z}_{P}} ) + {C}_{T}$$

$${C}_{S} = 1.5 \% * \frac{5 kg}{15 kg} + 1.5 \%$$

$${C}_{S} = 2 \%$$

4) Prepare slurry of 5 kg of non-catalyzed resin and 5 kg expandable graphite placing it in storage tank “A” (see FIG. 1).
5) Prepare resin for second stream adding 2% catalyst to resin and place in storage tank “13” (see FIG. 1).
15 kg of PU resin ±0.300 kg of catalyst
6) Determine the dispensing flow rates for each stream of PU resin and the isocyanate.

D_{F}=I_{F}+N_{F}+S_{F}

D_{F}=(I_{R}*P_{TF})+(P_{TF}−P_{SF})+(A_{R}*P_{TF}+S_{R}*A_{R}*P_{TF})

D_{F}=(I_{R}*P_{TF})+(P_{TF}−S_{R}*A_{R}*P_{TF})+(A_{R}*P_{TF}+S_{R}*A_{R}*P_{TF})

D_{F}=(1+I_{R}+A_{R})*P_{TF}

200 g/s=(1+0.5+0.25)*P_{TF}

200 g/s=1.75*P_{TF}

P_{TF}=114.29 g/s

A_{F}=A_{R}*P_{TF}

A_{F}=0.25*114.29

A_{F}=28.57

P_{SF}=S_{R}*P_{TF}

P_{SF}=1*28.57

P_{SF}=28.57

S_{F}=P_{sF}+A_{F}

S_{F}=28.57+28.57

S_{F}=57.14 g/s

N_{F}=P_{TF}−P_{SF}

N_{F}=114.29−28.57

N_{F}=85.72 g/s

I_{F}=I_{R}*P_{IT}

I_{F}=0.5*114.29

I_{F}=57.15 g/s

The flow rates for the slurry, catalyzed resin, and isocyanate determined by these equations are used to set the flow rate parameters for the dispensing equipment.

Although the invention is illustrated and described herein with respect to particular polymers or polymerization reactions, it is nevertheless not intended to be limited to the details shown, since various modifications to the identified system, and the selected reactants, catalysts, additives, and other materials may be made without departing from the scope of the invention and equivalents thereto.

What is claimed is:

1. A method for producing polymeric product, comprising the steps of:
selecting first reactant and at least one second reactant of a polymerization reaction, wherein the polymerization reaction produces a polymeric product;
selecting a catalyst for enabling or accelerating the polymerization reaction;
selecting an additive for producing a desired characteristic of the polymeric product;
placing a first portion of the first reactant in a first storage container with an amount of the additive, creating a first mixture, the amount of the additive being sufficient to produce the desired characteristic of the polymeric product;
placing a second portion of the first reactant in a second storage container with an amount of the catalyst, creating a second mixture the amount of the catalyst being sufficient to enable or accelerate the polymerization reaction;
placing at least a portion of the at least one second reactant in a third storage container;
combining the first mixture, second mixture, and the second reactant into a combined mixture; and
dispensing the combined mixture, wherein the combined mixture results in the polymeric product.

2. The method of claim 1, wherein the first reactant is a polyol and the second reactant is an isocyanate.

3. The method of claim 1, wherein the additive is expandable graphite.

4. The method of claim 1, wherein the polymeric product is polyurethane foam.

5. The method of claim 1, wherein the amount of the additive in the first mixture is determined by:
selecting an amount of first reactant for the polymerization reaction;
selecting a ratio of the additive to the first reactant for the polymerization reaction; and
calculating the total amount of additive for the polymerization reaction.

6. The method of claim 1, wherein the step of combining the first mixture, second mixture, and the second reactant into a combined mixture additionally comprises the steps of:
determining a flow rate for the first mixture from the first storage container to a dispensing device;
determining a flow rate for the second mixture from the second storage container to the dispensing device; and
determining a flow rate for the second reactant from the third storage container to the dispensing device,
whereby the flow rates for the first mixture, second mixture, and second reactant are sufficient to enable the polymerization reaction.

7. The method of claim 6, whereby the flow rates for the first mixture, second mixture, and second reactant result in a stoichiometric ratio of the first reactant and the second reactant in the combined mixture.

8. The method of claim 1, wherein the step of combining the first mixture, second mixture, and the second reactant is done on a continuous basis.

9. The method of claim 7, wherein the step of dispensing the combined mixture is done on a continuous basis.

10. The method of claim 1, wherein the first mixture is heated prior to the combining step.

11. A method for producing a polyurethane foam product, comprising the steps of:
selecting first reactant and at least one second reactant of a polyurethane polymerization reaction, wherein the polyurethane polymerization reaction produces a polyurethane foam product;
selecting a catalyst for enabling or accelerating the polyurethane polymerization reaction;
selecting an additive for producing a flame-block property of the polyurethane polymeric product;
placing a first portion of the first reactant in a first storage container with an amount of the additive, creating a first mixture;
placing a second portion of the first reactant in a second storage container with an amount of the catalyst, creating a second mixture;
placing at least a portion of the at least one second reactant in a third storage container;
the amount of the additive in the first mixture being sufficient to produce the flame-block property of the polymeric product;
the amount of the catalyst in the second mixture being sufficient to enable or accelerate the polymerization reaction;
combining the first mixture, second mixture, and the second reactant into a combined mixture; and
dispensing the combined mixture, wherein the combined mixture results in the polymeric product.

12. The method of claim 10, wherein the first reactant is a polyol and the second reactant is an isocyanate.

13. The method of claim 10, wherein the additive is expandable graphite.

14. The method of claim 10, wherein the amount of the additive in the first mixture is determined by:
selecting an amount of first reactant for the polymerization reaction;
selecting a ratio of the additive to the first reactant for the polymerization; and
calculating the total amount of additive for the polymerization reaction.

15. The method of claim 10, wherein the step of combining the first mixture, second mixture, and the second reactant into a combined mixture additionally comprises the steps of:
determining a flow rate for the first mixture from the first storage container to a dispensing device;
determining a flow rate for the second mixture from the second storage container to the dispensing device; and
determining a flow rate for the second reactant from the third storage container to the dispensing device,
whereby the flow rates for the first mixture, second mixture, and second reactant are sufficient to enable the polymerization reaction.

16. The method of claim 15, whereby the flow rates for the first mixture, second mixture, and second reactant result in a stoichiometric ratio of the first reactant and the second reactant in the combined mixture.

17. The method of claim 10, wherein the step of combining the first mixture, second mixture, and the second reactant is done on a continuous basis.

18. The method of claim 17, wherein the step of dispensing the combined mixture is done on a continuous basis.

19. The method of claim 10, wherein the first mixture is heated prior to the combining step.
